(19) United States
(12) Patent Application Publication
(10) Pub. No.: US 2025/0061634 A1
(43) Pub. Date: Feb. 20, 2025

(54) AUDIO-DRIVEN FACIAL ANIMATION USING MACHINE LEARNING

(71) Applicant: Nvidia Corporation, Santa Clara, CA (US)

(72) Inventors: Zhengyu Huang, Shanghai (CN); Rui Zhang, Beijing (CN); Tao Li, Beijing (CN); Yingying Zhong, Shanghai (CN); Weihua Zhang, Beijing (CN); Junjie Lai, Beijing (CN); Yeongho Seol, Seoul (KR); Dmitry Korobchenko, London (GB); Simon Yuen, Playa Vista, CA (US)

(21) Appl. No.: 18/457,251

(22) Filed: Aug. 28, 2023

(30) Foreign Application Priority Data
Aug. 16, 2023 (CN) 202311036144.8

(51) Int. Cl. G06T 13/20; G06T 13/40; G10L 15/16

(52) U.S. Cl. CPC G06T 13/205; G06T 13/40; G10L 15/16

(57) ABSTRACT

Systems and methods of the present disclosure include animating virtual avatars or agents according to input audio and one or more selected or determined emotions and/or styles. For example, a deep neural network can be trained to output motion or deformation information for a character that is representative of the character uttering speech contained in audio input. The character can have different facial components or regions (e.g., head, skin, eyes, tongue) modeled separately, such that the network can output motion or deformation information for each of these different facial components. During training, the network can use a transformer-based audio encoder with locked parameters to train an associated decoder using a weighted feature vector. The network output can be provided to a renderer to generate audio-driven facial animation that is emotion-accurate.

### CROSS-REFERENCE TO RELATED APPLICATION

This application claims priority to and the benefit of Chinese Patent Application No. 202311036144.8, fled Aug. 16, 2023, titled “AUDIO-DRIVEN FACIAL ANIMATION USING MACHINE LEARNING,” the full disclosure of which is hereby incorporated by reference in its entirety for all purposes.

### BACKGROUND

It may be desirable for various operations to animate a character to appear as if that character is uttering speech represented by audio data. Due in part to the time and complexity of creating such animation, it can be beneficial to automate such a process, particularly for real-time or near real-time operations. Machine-learning based approaches have been used to generate animation of characters based on input audio, but these prior approaches are generally limited in their capabilities, producing animation that is not sufficiently realistic in many instances. For example, a prior approach can attempt to animate various facial features of a character, including the mouth or eyes, in order to correspond to speech represented by corresponding audio data—but these models often fail to provide realistic animations when used on languages that the model is not explicitly trained for. This issue may be exacerbated for operations where the character is a virtual human that is intended to appear as an actual human that is uttering the speech in a realistic manner with realistic behavior.

### BRIEF DESCRIPTION OF THE DRAWINGS

Various embodiments in accordance with the present disclosure will be described with reference to the drawings, in which:

FIGS. 1A and 1B illustrate aspects of a character that can be animated based, at least in part, upon speech data, in accordance with at least one embodiment;

FIG. 2 illustrates an example network for generating animation to correspond to speech, including emotion and style support, in accordance with at least one embodiment;

FIG. 3 illustrates an example network for generating animation to correspond to speech, in accordance with at least one embodiment;

FIG. 4 illustrate example training process for a network to generate animation of a character to correspond to input audio, according to at least one embodiment;

FIGS. 5A and 5B illustrate example inferencing processes for a network to generate animation of a character to correspond to input audio, according to at least one embodiment;

FIG. 6 illustrates components of a distributed system that can be utilized to update or perform inferencing using a machine learning model, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

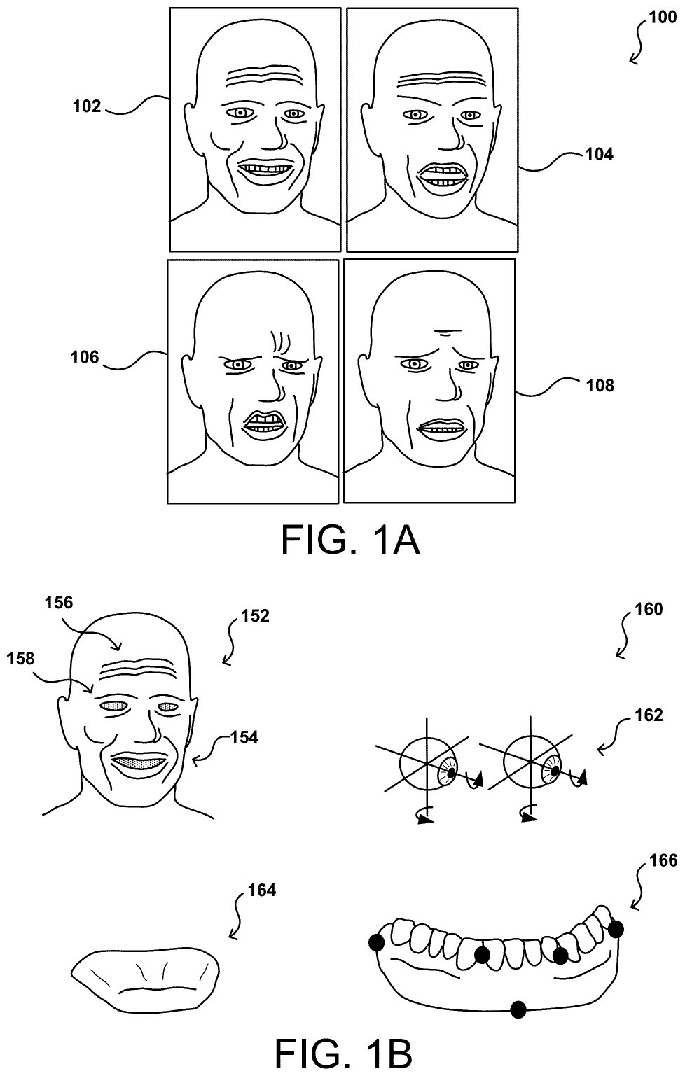

FIG. 1 1 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous vehicles or machines (e.g., in an in-cabin infotainment or digital or driver virtual assistant application)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments can generate animation that is representative of one or more characters uttering speech represented by audio data. This can include, for example, high resolution, full three-dimensional (3D) facial animation for presentation as part of a movie, game, artificial intelligence (AI)-based agent, digital avatar, teleconference, virtual/augmented/mixed/enhanced reality experience, and/or other media presentation, content, or experience. One or more deep neural networks, such as a frame-based convolutional neural network (CNN), or recurrent neural network (RNN), and/or a transformer-based model can take as input raw audio, extract features from the raw audio, and receive one or more component vectors with which a character is to be animated to utter speech contained in an audio segment extracted from the input raw audio. The network can then provide output, such as motion, vertex, and/or deformation data, that can be provided to a renderer, for example, in order to generate or synthesize the facial animation corresponding to that portion of the speech. During training, the network may receive, in addition to audio input, one or more component vectors, such as a style vector or an emotion vector, that indicates one or more emotions, with potential relative weightings, to use to render the facial animation for an input audio clip. The emotion(s) indicated by the data may change at various points, or keyframes, in the audio data. The network may also receive a style vector (or style information incorporated in the emotion vector or other emotional data representation) that indicates a modification or fine control of the animation to be generated for the indicated emotion(s), as may relate to a style of animation or may relate to specific motions to be modified or enhanced, among other such options. The motion or deformation information output by the network can correspond to a set of facial (or other body) components or portions that can be animated, at least somewhat independently, to realistically represent the character uttering input speech. These components can include, for example, a head, jaw, eyeballs, tongue, or skin of the character. In embodiments, in addition to or alternatively from facial components or portions, body components or portions—such as arms, legs, torso, neck, etc.—may be modeled. Modeling each of these facial (and/or body) components separately, and determining deformations for each of these components, can cause the rendered facial (and/or body) animation to appear more realistic for a given emotion, particularly when considering any style data provided to the network.

Various systems and methods are directed toward incorporating one or more transformer-based audio encoders into an Audio2Face model. Various embodiments make changes to a formant analysis network of the Audio2Face model to modify existing CNN-based systems with a pre-trained transformer model. In at least one embodiment, modifications include, at least in part, incorporating one or more transformer layers into an audio encoder model that may also include one or more CNN layers. The model may be pre-trained on audio data, which may include a variety of different languages, and then used within the Audio2Face model to help train a decoder in order to generate a set of vectors for use by one or more application-specific outputs, such as within a renderer to generate an animated face (e.g., a character) that replicates how a human face may say the input audio sample. The pre-trained transformer model may include a number of layers and, given an input set of features from CNN layers, each layer may produce a set of vectors associated with those features. Systems and methods add a combination layer that may include learnable weights that can be applied to linearly combine each of the output vectors for each layer in order to generate a final output. The weights of the combination layer may be learned as the model is trained through back propagation. Various embodiments may be used with small duration audio samples (e.g., approximately less than 1 second, approximately less than 0.8 seconds, approximately less than 0.6 seconds, approximately between 0.4 seconds and 0.6 seconds, approximately between 0.6 seconds and 0.8 seconds, approximately between 0.8 seconds and 1 second, or any other reasonable duration) and may not incorporate information from previous frames. As a result, a user may select any portion of a larger audio clip for evaluation and viewing without losing output quality due to lack of prior frame knowledge. Additionally, techniques to improve output quality may be incorporated. In at least one embodiment, an additional regularization loss is incorporated to reduce motion jitter during silence. The loss may penalize large motion between neighboring animation frames, for example, if the sound volume is low. Furthermore, one or more embodiments may also incorporate lip distance loss to picks key points on the upper/lower lips of the character and then minimize the difference between predicted and ground truth distance between upper/lower lip key points.

When generating such image or video data for various operations, it can be a goal (or in at some examples required) for a representation of a character—such as a human, robot, animal, or other such entity—to behave as realistically as possible. Such realistic behavior may include various movements or actions in various states and under various conditions. For example, a character such as a character corresponding to the head region illustrated in a set 100 of images illustrated in FIG. 1A might be animated to have their mouth, face, and/or head move in such a way as to convey that the character is uttering speech represented by audio data, which may be provided for playback or other presentation along with this animation. In order to make this animation appear as realistic as possible, it may not be enough to move only the mouth of the character to appear to utter the words in the speech, as an emotional state or set of circumstances might impact how the character physically moves other elements (e.g., eyes, tongue, etc.) of their face while uttering that speech. For example, the character might be animated to utter the words “I'm here.” Simply animating the mouth to correspond to the formation of the words is not sufficient to convey realism in various situations, as the user might utter those words with very different intent, emotion, and/or style. For example, as illustrated in a first image 102 the character might be animated to utter the words with a happy emotion, such as where the character has arrived home to their family and is happy to see them. In a second image 104, the character might be angry that they were called to a certain location, and may express anger when conveying that they have arrived. In a third image 106, the character might be feeling a sense of disgust, such as where the character is in a place that they really do not want to be but are compelled to visit. In a fourth image 108, the character might feel a sense of sadness, as the character may announce their arrival but had felt a need to arrive due to undesirable circumstances. There may be any of a number of other emotions that may be experienced by the character that are to be conveyed in different instances. In order to make this animation appear realistic, an animation system (or other image data generation or synthesis system, component, module, or device) can accept or infer an emotional state, and attempt to generate animation of this character that not only matches any audio to be uttered by this character, but also conveys that utterance with an emotional behavior.

As illustrated, conveying of emotional behavior can include a number of different but related motions. For example, an outer surface of the user's head—corresponding to the skin 152 on the head as illustrated in FIG. 1B—can be deformed to convey both speech and emotion. This can include moving the lips 154 of the character to match the formation of the words being uttered in order to cause an animation of this character to appear to be uttering the speech. As mentioned, the lip motion may also be determined based, at least in part, upon an emotional state of that character while uttering that speech. There can be other aspects of the skin (or head) that may exhibit related behaviors based, at least in part, upon emotional state as well. For example, an amount or type of head movement (e.g., rotation or tilting of the head) may vary with different emotional states. Further, aspects such as certain wrinkles 156 or lines in the skin of the character may change for different emotions, such as to become more or less prominent or to take on specific shapes. Similar emotion-based behavior can be exhibited by other skin regions or features as well, such as by the eyebrows 158, checks, and so forth.

In addition to this outer skin or surface, there may be other aspects or features of this character that may change behavior with different emotions, which may be only somewhat related to the behavior of the skin or surface, as may be due to physical or kinematic constraints of the character. For example, the eyes 160 of the character can be modeled at least somewhat separately from the face. The position 162 of the eyes can be dependent upon the location of the head or skin of the character, as the position of the eyes is relatively fixed within the eye sockets of the character, but the motion or orientation of the eyes can be at least somewhat independent of the behavior of the skin. For example, this character if angry might focus directly on a person to whom they are speaking, while this character might look away from another person if feeling sad or guilty. Similarly, an amount of saccadic movement, or a frequency with which the character changes a point of focus of their eyes, may change for different emotions. Thus, it can be desirable to infer eye orientation at least somewhat separately from skin, head, or surface behavior.

Conventional eye tracking solutions may not provide adequate performance. In at least one embodiment, pupil tracking can be performed from the input 3D capture data using an algorithm, such as a Lucas-Kanade optical flow algorithm, which provides a differential approach to optical flow estimation that assumes optical flow is essentially constant locally, and solves for basic optical flow within that local neighborhood, In instances where a blink or obstruction occurs, or where at least one eye is no longer visible in the captured image data, at least some amount of interpolation can be performed based on one or more prior (or subsequent, if available) image frames. Such eye tracking approaches may also capture small saccade movements of the eyes, which can help to make eye movement appear more natural in the rendered facial animation. Such an approach can model eye movement accurately without requiring image data representative of an image(s) focused primarily on the eyes of the actor while uttering the speech.

Similarly, the tongue 164 of the character can move at least somewhat independently from the head, within physical or kinematic constraints. An amount or type of tongue movement may vary with emotion, as a sad character might exhibit very little tongue movement, while an angry or excited character might exhibit a lot of tongue movement, which may differ in direction or pattern as well. Furthermore, movement of the tongue 164 may also be related to a language spoken by the character, as different sounds may not be present in each language. An appropriate number of feature points can be used for a tongue mesh, allowing for realistic motion and behavior through, for example, mesh deformation. This number of points can be reduced or compressed (to a number such as, without limitation, 10 points) through a process such as principal component analysis (PCA) in order to reduce an amount of processing and memory needed for tongue mesh deformation.

There may also be other aspects or features of a character that may be modeled separately to improve realism as well. For example, a jaw 166 of the character may be modeled separately from the head of the character. While movement of a jaw may be able to be approximated through skin movement and deformation, it was observed that for at least some systems or implementation such inference may not be sufficiently accurate to avoid any post processing or manual cleanup of the produced animation. In order to improve accuracy, movement of this jaw 166 can be modeled separately, as the jaw can move in many different directions by different amounts for a similar state of the skin, such as where the character has their lips closed, but it may be difficult to capture this motion based on skin deformation alone. There may be other aspects, features, or components of a character that may benefit from being separately modeled as well, which may depend at least in part upon a type of character, as an animal, robot, or alien may be modeled to have different skeletal structure or kinematic capability. Different types or instances of the same character may also exhibit different behaviors or different emotions, such as people of different ages, genders, backgrounds, or other such aspects.

In many instances, a user may not exhibit only a single emotion, or may exhibit different levels of one or more emotions. For example, for an “angry” emotion type, the character might behave very differently if the character is slightly upset rather than if the character is enraged. A character may also be exhibiting multiple emotions at once, such as a character who is both happy that a child was accepted to college but sad that the child will be moving away, and thus would realistically exhibit traits associated with a combination of both emotions. There may also be characters that have different styles of behavior for a same emotion, at least under certain circumstances. For example, a character might act differently if talking to a stranger than to a partner, parent, or child. A character might also act differently if in a professional setting than a personal setting. In some instances, such as for a game or movie, an animator may simply want a specific look, style, or behavior exhibited by a character for a certain emotional state. Accordingly, it can be beneficial for at least some approaches presented herein to allow a user (or application or operation, etc.) to specify more than one emotion, or a combination of emotions. In some operations, a user (or other source) may also be able to specify weightings of these various emotions, in order to provide for more accurate combinations of emotion. A user may also be able to specify different emotions, combinations, or weightings at different time points or emotional “keyframes” in the animation, such as where a character might get increasingly sad or may calm down during a discussion. A user may also be able to specify a style with which a character conveys an emotion, which may also vary over time, such as at different keyframes in the animation.

Approaches in accordance with various embodiments can use at least some of these and other such aspects or features to provide for facial animation that provides realistic behavior under various emotional states for a variety of different character types and for a variety of different input audio types. This can include, for example, audio-driven full three-dimensional (3D) facial animation with emotion control. In such an approach, realistic animation can be generated without any manual input or post-processing required—although possible where desired. Automating such animation can help to significantly reduce the amount of time, experience, and cost needed for manual (or at least partially-manual) character animation. Audio-driven facial animation can provide an efficient way to generate facial animation compared to traditional approaches, as only audio data is needed to drive the animation of a given character. Prior attempts at audio-driven animation could animate the lower face for lip synchronization, but were unable to generate proper motion or behavior for other facial areas or features—such as the upper face, teeth, tongue, eyes, and head—which may be needed for accurate behavior representation. In prior approaches, it was often necessary to use additional manual or post-processing efforts to correct for inaccurate behavior in the generated animation. Prior attempts to include emotion in animation for speech typically also focused only on a single type of emotion for a duration of speech, which did not capture or accurately represent natural changes or shifts in behavior in many situations, which then also often required additional manual or post-processing efforts. Furthermore, models used in prior approaches often failed to generalize between different language or audio inputs, such as non-language inputs (e.g., yelling, gasping, sobbing, etc.). In an attempt to address these problems, prior approaches incorporated additional training data for language-specific applications or added application-specific loss functions, which increased complexity and cost for facial animations.

Approaches in accordance with various embodiments can provide for automated, audio-driven animation, such as full 3D facial animation, with variable emotion control, that can generalize over different languages and/or non-language audio inputs. In at least one embodiment, one or more aspects of an animation pipeline are configured to include a pre-trained audio encoder that incorporates one or more transformer layers. This encoder may be trained on a variety of different languages and/or multi-lingual audio slips, to compute audio features from an input audio segment over a time axis. Computed audio features from each transformer layer may be linearly combinable using learnable weights. The combined audio features may then be passed along the pipeline to one or more audio decoders for estimating various animation coefficients, which may be used by one or more renderers to render a character with facial movement associated with an audio input. In at least one embodiment, the pre-trained audio encoder is frozen during training, which may reduce the likelihood of overfitting, and therefore during training only the decoder and the linear combination layer weights may be modified. Systems and methods may be used both offline and in real-time and/or near-real-time (e.g., without significant delay).

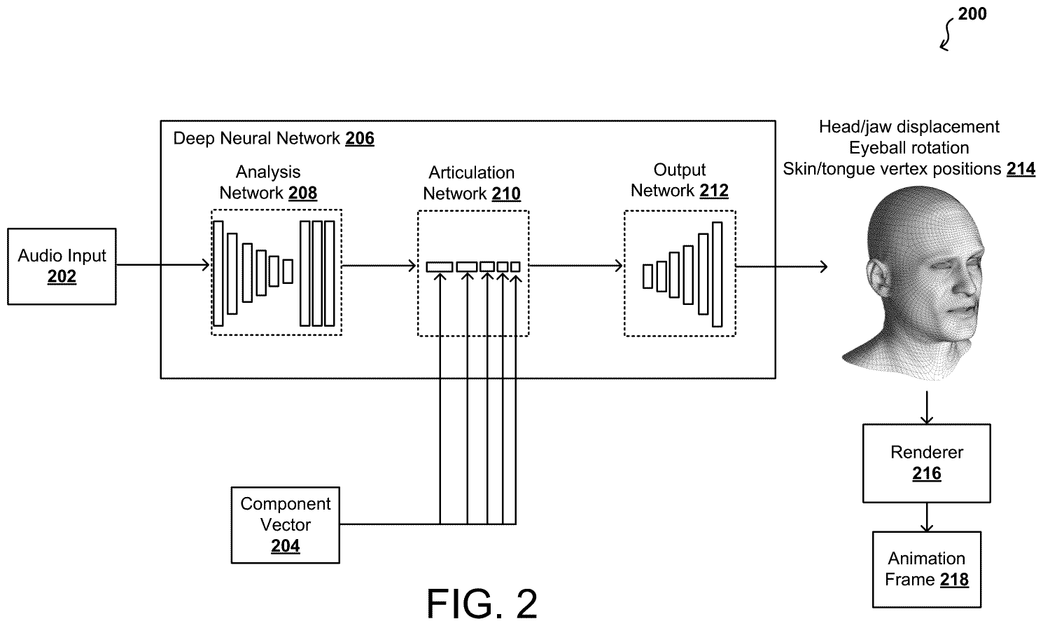

In at least one embodiment, a collection of speech performances can be captured of one or more actors uttering speech (e.g., specific sentences) with different languages, different non-language audio, emotions, levels of emotion, combinations of emotion, or styles of presentation, among other such options. Emotions, as one example of an input component vector, supported by such a system can include any appropriate emotion (or similar behavior or state) that is able to be at least partially represented through character animation, image synthesis, or rendering, as may include joy, anger, amazement, sadness, pain, or fear, among others. A data collection process can include a capture of, for example, 4D data, including multi-view 3D data over at least a period of time of utterance of the speech. Reconstruction of this captured facial behavior can be performed not only for the facial skin (or such surface), but also for other articulable or controllable components, elements, or features, as may include the teeth, eyeballs, head, and tongue (and/or body features or components, such as limbs, fingers, toes, torso, etc.). The reconstruction can provide geometric deformation data in the temporal domain for each separately (or at least somewhat separately) modeled facial (or other bodily) component or region. Such reconstruction can provide a full dataset for use in training, for example, a deep neural network 206 (as illustrated in FIG. 2) to perform a task such as 3D facial animation.

In at least one embodiment, a frame-to-frame mapping can be used to generate single animation frame output. For example, single frame audio (e.g., approximately 0.52 s) may be processed with a corresponding single animation flame output. In the example system 200 of FIG. 2, an audio input 202, which may include one or more of raw audio, audio frames, a segment of audio within a current audio window, etc., may be provided as input to the deep neural network, which can use an analysis network portion 208 to analyze the audio and encode features representative of features of the audio in the audio data 202, as may correspond to a portion of the speech. This analysis network portion 208 may include one or more audio decoders and encoders for encoding audio features into a feature vector, which as noted herein, may be one or more combined audio features from transformer layers. The feature vector may be provided as input to an articulation network portion 210 of the deep neural network 206. In this example, a component vector 204 can be provided as input. In some embodiments, multiple vectors may be provided, such as an “emotion” vector and a “style” vector, among various other options and combinations. Additionally, a single vector may be provided as input that includes both style and/or emotion data, such as by using a fusion process. An emotion vector may include data for one or more emotions that apply to speech being used for training, such as an emotion that the voice actor was instructed to use when uttering the speech that was captured in the audio data. In some instances, this may include data for a single emotion label, such as “anger, “or may include data for multiple emotions, such as “anger” and “sadness,” as well as potentially relative weightings of those two emotions. These labels and/or weightings may have been provided to the voice actor initially, may have been determined after the speech was uttered, and/or may involve updated labels after hearing the speech that was uttered for an audio capture for a specific emotion, among other such options.

In at least one embodiment, the component vector 204 may corresponds to a style vector provided as input to the deep neural network 206 during training (and similarly in deployment). A style vector can include data relating to any aspect of the animation or facial component motion that modifies how one or more points for one or more facial components should move for a given emotion or emotion vector. This may include impacting motion of specific features or facial components, or providing a style of overall animation to be used, such as “intense” or “professional.” A style vector may also be viewed as a finer-grained control over emotion, where an emotion vector provides the label(s) of the emotion(s) to use, and the style provides finer control over how the emotion(s) is expressed through the animation. Other approaches to determining style data can be used as well. In different implementations, a single set of emotion and style vectors may be provided for a given audio clip, a set of vectors can be provided for each frame of animation to be generated, or a set of vectors can be provided for specific points or frames of animation (e.g., emotional keyframes) where at least one emotion or style value or setting is to be modified relative to a prior frame.

In this system 200, the component vector 204 is fed into an articulation network portion 210 of the deep neural network 206 at multiple levels, including at least a beginning and an end of the network to help condition the network. The deep neural network 206 may use a shared audio encoder and one or more (e.g., multiple) decoders for each facial component (e.g., face skin, jaw, tongue, eyeballs and head). During training, an output network portion 212 of the deep neural network 206 can generate a set of head/jaw displacements, eyeball rotations, and skin/tongue vertex positions/or PCA coefficients of vertices 214 and/or motion vectors (or other motions or deformations) for individual feature points of the facial components, whether for each such feature point or for only those that have changed relative to a prior frame, among other such options. During training, these vertex positions/or PCA coefficients can be compared against “ground truth” data, such as the original reconstructed facial data from the (e.g., 4D) image capture, in order to compute an overall loss value. In at least one embodiment, a loss such as an L2 loss can be used for both position and velocity of feature points in an output data representation. A loss function used to determine the loss value can include terms for position, motion, and adversarial loss in at least one embodiment. This loss value can be used during backpropagation to update network parameters (e.g., weights and biases) for the deep neural network 206. As noted herein, in at least one embodiment, the weights for the audio encoder may be frozen such that the backpropagation is used to only update one or more decoders. Once the network is determined to converge to an acceptable or desired level of accuracy or precision, and/or another training end criterion is satisfied (e.g., processing all training data or performing a target or maximum number of training iterations), the trained network 206 can be provided or deployed for inferencing.

During inferencing, the network may receive the audio input 202 (e.g., only audio data in some embodiments) as input, and may infer a set of vertex positions 214 for various facial components (e.g., head, face, eyeballs, jaw, tongue), which can then be fed to a renderer 216 (e.g., a rendering engine of an animation or video synthesis system) in order to generate a frame of animation 218, which may be one of a series of frames that provide the animation upon presentation or playback. As discussed in more detail elsewhere herein, emotion or style vector data may also be provided as input to the deep neural network 206 if the generated vertex positions are to be modified in some way with respect to how the deep neural network 206 would otherwise infer the vertex positions based on the audio data, such as to convey a specific style or facial behavior to be used in inferring the vertex positions 214.

A deep neural network 206, as described in more detail later herein, can output a vector that encodes position or motion data for various points on a mesh for one or more facial components, and can feed this output vector (or another output, such as a global transformation matrix) to a renderer 216 that can apply these values to one or more meshes for this character in order to guide the animation. This output matrix or vector can have a dimension that matches the features of the facial components, as may include, for examples and without limitation, 272 facial feature points for the skin, five for the head, five for the jaw, two for the eyeballs, ten for the tongue (using PCA compression, for example), and so on. Such an approach can provide a sufficiently smooth animation, such that additional smoothing or post-processing will not be needed in at least many situations. A system may, however, allow for additional smoothing to be applied, such as where a user may be able to specify one or more smoothing parameters.

The size of the audio data, and/or a window of the audio data, can be any appropriate or suitable size and may depend in part upon the implementation, but at a minimum can include a period of time corresponding to a frame of animation for a target frame rate (e.g., 60 Hz), and can include larger windows in order to consider portions of audio for nearby frames (e.g., prior or subsequent) in order to provide for more accurate and smooth animation, as well as more accurate emotion and/or style determination from the input audio. An example system can use one-hot vector encoding to represent different emotions, or emotional labels, with the resulting emotion vectors can be concatenated at one or more layers.

In at least one embodiment, the output of such a network can include data specifying motion for different facial parts or components. The output may include data for components of a character beyond just facial components as well, as may relate to arms, legs, torso, and the like. Such a system may also generate accurate motion data for a character for frames or scenes where a face of the character is not visible, or is only partially represented in the scene. For facial parts with non-rigid deformation such as skin and tongue, captured (e.g., 4D) motion data can be compressed using, for example, Principal Component Analysis (PCA). This can allow a facial mesh with a large number of points, such as 60,000 points, to be represented by a vector of a much smaller dimension, as may correspond to 272 (or another number of) feature values. In such embodiments, the PCA weight vectors can be used as a training representation. In one embodiment, a fully-connected layer can fuse emotion and/or style data into a smaller vector, which can be inserted as a concatenation into individual layers of the network.

For facial parts with rigid transforms, such as head and teeth, a number (e.g., without limitation, 5 as illustrated in FIG. 1B) of markers or feature points can be selected or identified on the target mesh, and a position delta of these points from the reference position can be used as a training representation from which a rigid transform matrix can be computed. For a jaw, these five feature points may include points at either end of the jaw, a center point, and two intermediate reference points, where those intermediate points may not be necessary but can help with fine motion control and noise reduction. For rotatable components such as eyeballs, the system can use two rotation values (e.g., pitch and yaw) to represent horizontal and vertical rotations relative to a default orientation. At runtime, or during inferencing, full 3D facial animation output can be obtained by such a system. Such a system can also allow for interactive control of emotion or style of this speech animation by feeding different component vectors 204 into the network, in order to allow for modifying or “fine-tuning” the motion of individual each facial components and facial regions, as may be part of a real-time or near-real time process, or as post-process.

In at least one embodiment, a deep neural network 206 can have a per-frame convolutional neural network (CNN)-based architecture. A per-frame CNN architecture can receive as input audio windows of, for example and without limitation, about 0.5 seconds, which can include data for prior and subsequent frames in a sequence, whereby the CNN can predict data for a middle frame in this sequence. Other architectures can be used as well within the scope of the various embodiments, which can also provide for a smoothness of animation based at least in part upon a context provided to, or determined by, those architectures. While different architectures may provide adequate results, certain architectures may perform better under certain circumstances or for certain aspects of speech-driven facial animation. For example, a CNN-based architecture performed well for real-time inferencing, and can generate very reliable lip synchronization motions.

In at least one embodiment, the deep neural network can be a transformer architecture. A transformer architecture may differentially weight a significant for each part of an input. The input data may be provided as a sequence, but may be processed all at once, with an attention mechanism providing context for a position of the input sequence. Transformers may include an encoder architecture where encoding layers iteratively process an input. The encoder determines relevant features of the input and passes these encodings to the next layer. Attention mechanisms may be incorporated to weigh relevance of each part of the input and/or output. For example, the attention mechanism may accepts input encodings from the previous encoder and weight their relevance to each other to generate output encodings. The encoder can then further process each output encoding individually in subsequent layers. These output encodings are then passed to the next encoder as its input.

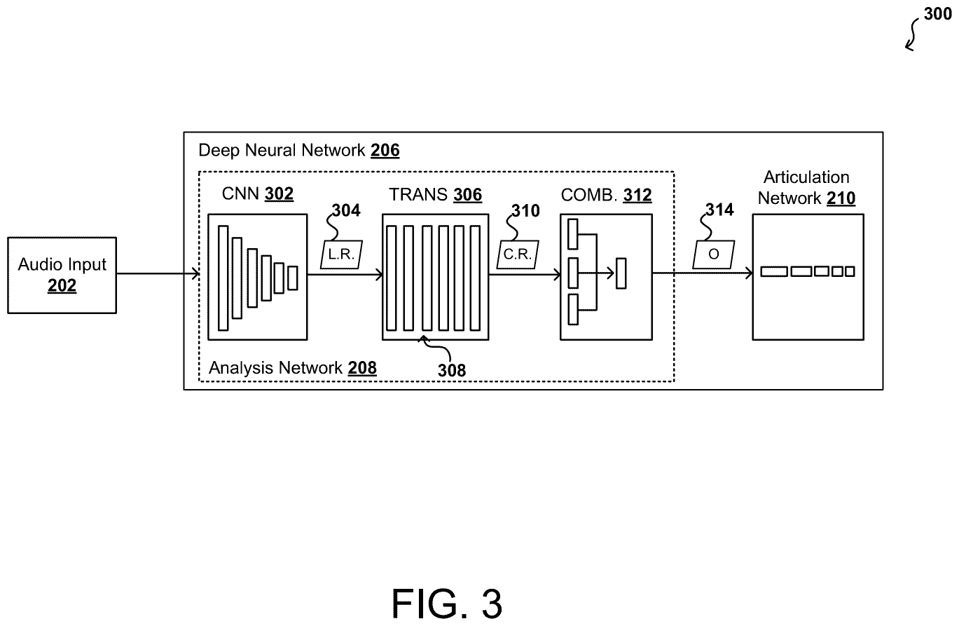

FIG. 3 illustrates an example system 300 representing one or more components forming the analysis network 208, that can be provided in at least one embodiment. In this example, an audio input 202 is received at the deep neural network 206. In at least one embodiment, the audio input 202 is a raw audio input, however, various embodiments may include audio inputs that have undergone one or more pre- or post-processing operations. The audio input 202 in this example is provided to a CNN 302, which may form a portion of the analysis network 208. The CNN 302 may be a part of, or at least provide information to, a multi-layer convolutional feature encoder that receives the audio input 202 and outputs one or more latent representations 304. The latent representations 304 may be provided for one or more time-steps and fed to a transformer 306 to determine representations for the sequence of information associated with the latent representations 304 and generate a series of context representations 310. In at least one embodiment, each layer 308 of the transformer 306 may generate a set of context representations 310 for the latent representations 304 provided by the CNN 302. For example, various embodiments may include approximately 25 different features, where the context representations would be developed, for each layer 308, for each of the 25 features.

In at least one embodiment, a combination layer 312 may include learnable weights that can be applied to linearly combine each of the output vectors for each layer 308 in order to generate an output 314. The weights of the combination layer 312 may be learned as the model is trained through back propagation. This output 314 may then be used by the articulation network 210, which may also receive the one or more component vectors 204 shown in FIG. 2, in order to generate position information for rendering a character model.

Various embodiments, mask the latent representations 304 prior to feeding the latent representations into the transformer 306. From there, contextualized representations can be established, such as via a contrastive learning process where different samples are contrasted against one another. The model may be pre-trained on unlabeled data and then fine-tuned with labeled data, among other options. Accordingly, systems and methods may use one or more models to build context representations with self-attention to capture dependencies.

In at least one embodiment, the CNN 302 includes a temporal convolution followed by layer normalization and an activation function, The audio input 202 may be a raw waveform that is normalized prior to processing. The transformer 306 may receive the output feature encodings. Each layer 308 may learn a number of features and output a vector for those associated features. The total number of features per layer 308 may be approximately 10 features, approximately 15 features, approximately 20 features, approximately 25 features, approximately 30 features, or any reasonable number of features. Furthermore, the number of features may be within a range of approximately 10 to 20 features, approximately 15 to 25 features, approximately 20 to 30 features, or any other reasonable range.

At the combination layer 312, each vector for each layer 308 may be weighted and then linearly combined to generate the output 314. The weights may be learned during training and/or may be tuned or adjusted based on different applications. The weighted vector indicates features from which transformer layer 308 is more useful, and linearly combine these features according to that determination. For example, if a feature from layer 1 is f1 and feature from layer 2 is f2, then these are fed into the combination layer 312, and the output is computed as f=(f1*w1+f2*w2)/(w1+w2), where w1 and w2 are the learnable weights.

In at least one embodiment, the audio input 202 may be a short audio sequence, such as one that is less than one second long. For example, the audio input 202 may be approximately 0.5 seconds long. Such small audio samples may provide the benefit of enabling real or near-real time applications. Furthermore, a given frame or audio clip may not be dependent or otherwise rely on a previous frame or audio clip. As a result, output animations may be “skipped” or tracked along different portions of the audio clip without losing information that would otherwise be needed if prior frames were relied upon.

Various embodiments of the present disclosure may also implement one or more techniques to improve output quality. For example, additional regularization loss may be added to reduce motion jitter during silences. The loss will penalize large motion between neighboring animation frames if the sound volume is low. Accordingly, there may be a reduced likelihood of movement between the frames, which would be expected if there were no sound, as the character would likely not be moving their mouth, as an example, if they were not speaking. Similarly, systems and methods may also apply lip distance loss to improve output quality. For example, key points may be selected on lips (e.g., an upper lip and a lower lip) and then a minimum difference between predicted and ground truth distance between the key points. The loss may have higher weights when the ground truth lip distance is small (e.g., when the mouth closed). As a result, the output character model may provide improved realism by guiding or otherwise encouraging mouth closing at appropriate times.

One or more embodiments of the present disclosure may train the transformer 306 such that parameters of the encoder are locked during training, but parameters of an associated decoder (e.g., a convolutional decoder) are permitted to change as a result of the training. For example, a pre-trained model may be used that is trained on different audio data, such as a number of different languages or sounds, and the associated parameters of the encoder may not change or otherwise be updated during the training process. In this manner, overfitting may be reduced and a smaller quantity of training data may be used.

Embodiments of the present disclosure incorporate the illustrated transformer 306 the deep neural network 206, such as within the analysis network 208, for processing one or more audio inputs 202, which my correspond to a window or clip of an audio segment. As noted herein, the audio segment may be a raw audio segment or may be a processed audio segment. Additionally, in at least one embodiment, the audio input may be buffered or otherwise clipped prior to processing within the deep neural network 206 and/or as part of the deep neural network 206 in one or more pre-processing stages. By way of example, the deep neural network 206 may take an audio buffer of a given length, such as length 8320 (e.g., approximately 0.52 s of audio) to compute audio features along a time axis. In certain embodiments, a number of audio features is determined by one or more properties of the CNN 302 and/or the transformer 306. For example, existing systems may evaluate approximately 50 different features. Various embodiments of the present disclosure may evaluate more or fewer features, such as approximately 25 features. These computed features may then be evaluated at each of the layers 308 of the transformer 306. Thereafter, the computed audio features from each transformer layer 308 may be linearly combined using learnable weights (e.g., at the combination layer 312), where the weights may be learned during one or more training operations. Additionally, in various embodiments, the weights may be tuned for particular applications based on one or more desired outputs. The linearly combined audio features are then passed to the audio decoder for estimating animation coefficients. As noted, in at least one embodiment, while parameters of the audio decoder may be adjusted or modified based on training information, systems and methods may use a pre-trained audio encoder that is locked or otherwise non-modifiable during training. That is, the pre-trained audio encoder is frozen and only the decoder weights are trained. In at least one embodiment, the decoder may be a convolutional decoder. Accordingly, due to the non-auto regressive nature, systems and methods may be used for both online and streaming (e.g., real time and/or near-real time).

Systems and methods of the present disclosure may be incorporated into one or more user interfaces that can be used to tune or otherwise modify a facial or bodily animation for one or more computer animated characters. For example, a user interface may be provided showing an animated representation of the character at different times and provide one or more inputs for the user to modify or adjust different parameters, such as tuning or otherwise changing different parameters of the one or more component vectors described herein. In various embodiments, the interface may be used for both training and inference purposes. For example, the user may evaluate reconstructions on the interface along with values associated with one or more features of the component vectors to label data that may be used for training purposes. In other embodiments, a user might also use such an interface to modify the reconstruction that is displayed.

The interface may include enable the user to evaluate reconstructions and animations at a given time over a duration of an audio clip. As noted herein, because various embodiments may generate animations over small time clips (e.g., approximately 0.5 seconds) and may also not use previous information when generating animations, the user may “skip” or otherwise move through different portions of the audio clip without losing out on reconstruction quality due to the lack of information from one or more preceding frames. For example, a user may begin looking at an animation at a time point corresponding to 20 seconds into the clip and then jump to a time point corresponding to 2 minutes into the clip without losing reconstruction quality due to not evaluating the frames between 20 seconds and 2 minutes of the clip. Because different time point within the audio clip may be associated without different outputs due to the context vector, various embodiments provide for improved review and viewing by enabling skipping or otherwise tracking through the audio clip.

As mentioned, such an interface can be used at inference time as a type of post process, which can also be used for continued learning in at least some embodiments. For example, a user may view generated animation playback through this interface, where animation of the character is presented. If the user thinks that the animation contains too much intensity for the situation, then the user can adjust one or more style selectors to reduce an intensity or modify one or more other parameters and have the frame(s) of animation re-rendered. If the user detects a little sadness in the character's speech that is not captured in the animation, then the user can adjust that setting as well. In some embodiments, a user may also be able to provide, as a type of style input, adjustment to specific feature points or facial components in the display. For example, the user can use a pointer to grab and move a position of the character's lip, and this information can be used as style input for re-rendering of the animation. Other changes can be provided as well, such as head movement, head tilt, eye movement or focus, or other such changes that can be conveyed through emotion or style input for re-rendering (or updated rendering or synthesis) of the animation. Various other animation control parameters can be specified through such an interface as well, which can impact the final rendering.

Various systems can also support retargeting. In retargeting, motion of one character can be mapped to motion of another character, such that similar animation can be generated for similar emotions and/or style. For example, retargeting may be applied to one or more (e.g., all) facial components such as skin, jaw, tongue, eyeball, etc. These facial components may be retargeted to more closely conform to or resemble the same facial components of a target or custom character. An interface can be further beneficial in a remapping context where different characters might express emotion or styles in slightly different ways. A user may be able to load different characters into this interface and view how a retargeted rendering would appear for that character, then can modify one or more aspects or a style of motion or behavior for that specific character, or type of character.

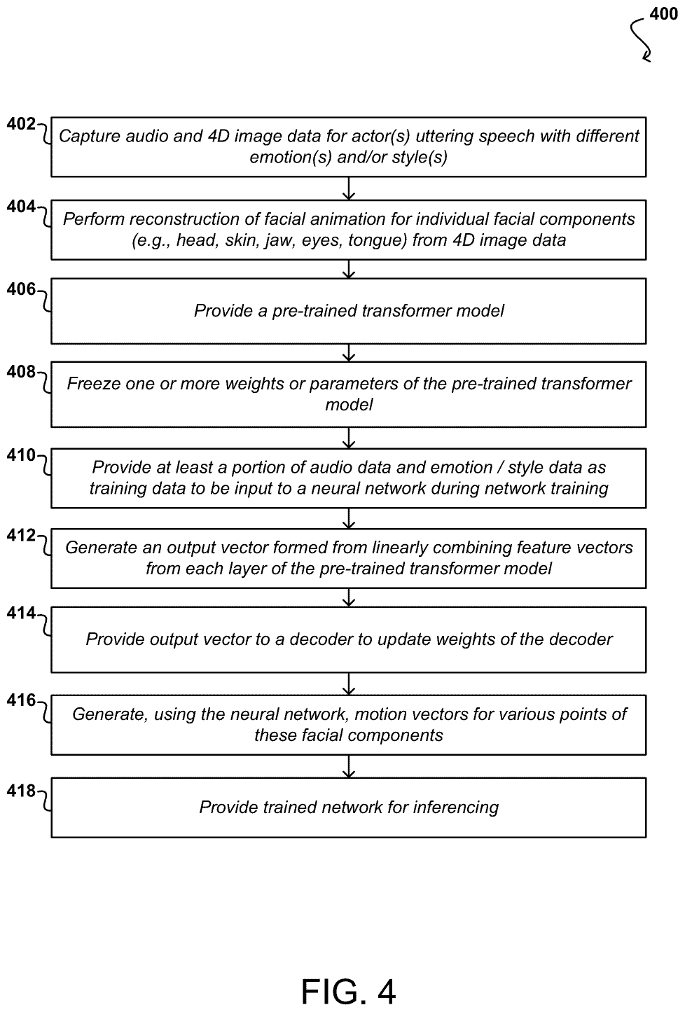

FIG. 4 illustrates an example training process 400 that can be used to train a neural network for a task such as facial animation, in accordance with at least one embodiment. It should be understood that for this and other processes presented herein that there may be additional, fewer, or alternative operations performed in similar or alternative orders, or at least partially in parallel, within the scope of the various embodiments unless otherwise specifically stated. Further, while this example refers to facial animation, it should be understood that various other such tasks can benefit from aspects of such a training process well within the scope of various embodiments. In this process, audio and 4D image data (and/or other image data, such as 2D image data, 3D image data, etc.) is captured 402, or otherwise obtained, for one or more actors uttering speech, including the same or different words or content, using different emotions and/or styles. In at least some embodiments, the actor uttering the speech will be instructed to utter the speech using at least a specified emotion or style, or some other parameter that can be modeled and represented using one or more component vectors, and is further to “act” out the parameter during the utterance to attempt to capture image or video data representing realistic physical motion or behavior of one or more facial or body components during utterance with the specified parameter (e.g., emotion, style, etc.). This capture may be performed for any different number of emotions or phrases, and may include sufficient instances of utterance of each emotion to enable accurate training of, for example, a deep neural network.

A reconstruction 404 of the facial animation can be performed in order to provide a sort of ground truth data, where a character mesh or other representation is deformed based upon the captured image data to provide a reference as to how facial components actually moved or deformed during utterance of specific speech with a specific emotion and/or style. Furthermore, the ground truth information may correspond to movement of various facial features, such as lips, jaw, etc. to determine whether accurate movement corresponds to the utterances associated with the audio data.

In at least one embodiment, a pre-trained transformer model may be provided 406. The pre-trained transformer model may be pre-trained on audio data, which may include a variety of different languages, and may be used as an audio encoder within one or more pipelines. The pre-trained transformer model may generate a set of encodings to that are used as input to different layers of the transformer model and/or to a decoder associated with the pre-trained transformer model. In at least one embodiment, providing the pre-trained transformer model includes locking or otherwise maintaining initial weights or parameters 408 of the pre-trained transformer model such that these weights or parameters are not changed or updated during a training process.

At least a portion of the training data can then be provided 410 for use in training a deep neural network. This can include, for example, for each frame of animation to be generated, a window of audio and component data, such as emotion data, for that frame. As mentioned, the audio and emotion data (as well as potentially any state data) can be used to generate feature vectors that can be provided as input to the network during training. As mentioned, sequence-to-sequence mapping can be used to obtain a sufficiently long temporal context for this input data, which can be beneficial in generating physically or behaviorally accurate animation.

The neural network, upon receiving and processing this data, can generate 412 an output vector corresponding to linearly combined output vectors for each frame of the pre-trained transformer model. For example, the input training data may be processed by one or more networks to extract one or more features, with these features being provided as an input to the pre-trained transformer model. The pre-trained transformer model may then output vectors for each layer of the model and pass these vectors to a combination layer to linearly combine the vectors from each layer into the output vector.

Once generated, the output vector may be provided to a decoder 414, which may be part of the pre-trained model or may be a separate decoder, to update weights of the decoder model based on the output vector. The decoder may then generate an output for use by one or more networks to generate 416 motion vectors for various point associated with the one or more features of the output vector. For example, the neural network may generate a set of motion vectors (or vertices or deformation values, etc.) for one or more facial feature points of one or more facial feature points of the character. This may include generating motion vectors for each facial feature point, or for only those feature points that undergo at least some amount of motion, among other such options. Then, the network can be deployed or otherwise provided 418 for inferencing, such as to generate facial animation data from input audio (and/or from an emotion vector(s) and/or a style vector(s)).

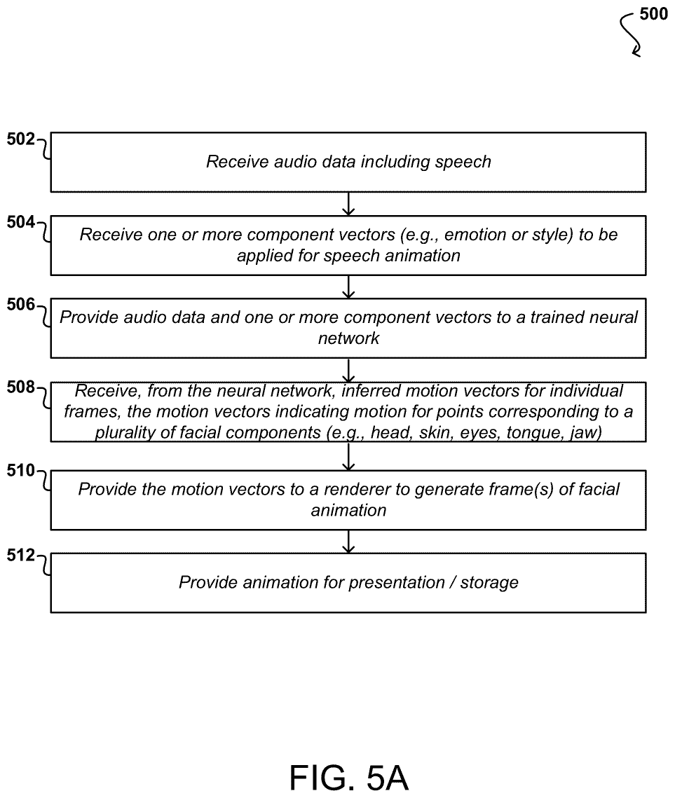

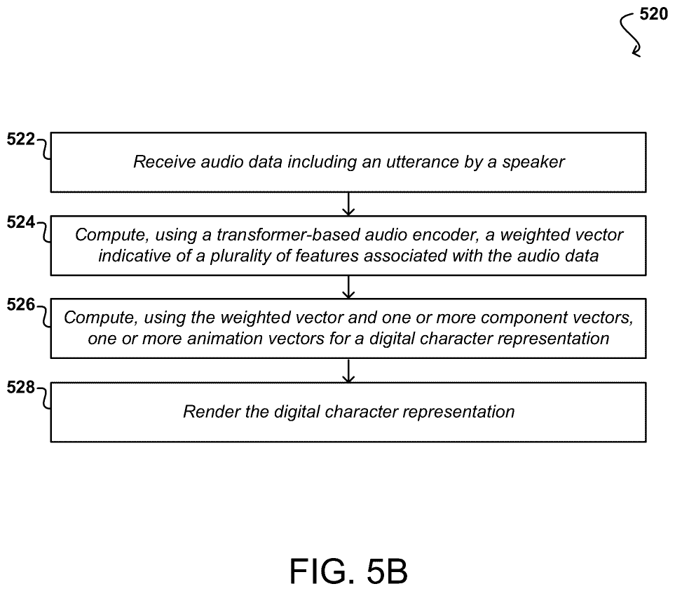

FIG. 5 illustrates an example process 500 for generating facial animation data using such a trained deep neural network, in accordance with at least one embodiment. In this example, audio data is received 502 that includes at least some speech data for which a character is to be animated. In addition to this audio data, there may be one or more component vectors including adjustments or settings—such as to emotion or style of animation—that is to be applied to the speech animation, which can be received 504 as additional input. This audio data and any received adjustment data can be provided 506 to a trained neural network, such as was trained using a process similar to the one described with respect to FIG. 4. This process can then receive 508, from this neural network, inferred motion vectors (or vertices, etc.) for individual frames of animation, where those motion vectors indicate motion for feature points corresponding to a plurality of facial (or other body) components, such as a head, jaw, skin, eyeballs, or tongue, among other such options. These motion vectors are inferred in order to provide realistic animation for a character uttering the speech represented in the corresponding portion of the audio data, and allow for separate modeling and behavior of these separate components, within kinematic, structural, and/or other such restrictions. In this example, these motion vectors can then be provided 510 to a renderer (or other such system, service, device, or process) for rendering one or more frames of facial animation by, for example, deforming one or more meshes for these facial components according to these motion vectors. This animation can then be provided 512 for purposes such as presentation or storage, among other such options.

FIG. 5B illustrates an example process 520 for generating facial animation data using such a trained deep neural network, in accordance with at least one embodiment. In this example, audio data is received that includes an utterance by a speaker 522. The audio data may include spoken phrases in a variety of languages and/or non-language spoken emissions, such as yelling, crying, sobbing, heavy breathing, and/or the like. In at least one embodiment, the spoken phrases may be accompanied by a particular style, which may include singing or the like. As a result, spoken phrases may refer to verbal emissions and not necessarily just speaking.

One or more neural networks may incorporate a transformer-based audio encoder to compute a weighted vector indicative of a plurality of features associated with the audio data 524. The plurality of features may be determined by one or more neural networks, such as by a CNN that extracts feature information from the audio input prior to providing the feature information to the transformer-based audio encoder. For example, the CNN may learn which features of the input audio data are relevant for a given task, identify those features, extract those features, and then provide those features to the transformer-based audio encoder.

In at least one embodiment, one or more animation vectors may be computed using the weighted vector and one or more component vectors 526. The component vectors may correspond to an emotion or style vector, among other options, that modifies different features of an output animation. For example, an emotion corresponding to “angry” may cause an output animation to cause a character to tighten their jaw and/or furrow their brow. Similarly, a style corresponding to singing may cause the animation to change their mouth position to project different words or to hold their mouth position open longer to emphasize certain notes or the like. Based on the one or more animation vectors, a digital character representation may be rendered 528.

Systems and methods of the present disclosure can allow a deep neural network to effectively process human speech and generalize over different speakers. Such a process can also allow a network to discover variations in training data that cannot be explained by the audio alone, as may relate to an apparent emotional state, style, or some other component driving animation. A three-way loss function as presented herein can also help to ensure that the network remains temporally stable and responsive under animation, even with highly ambiguous training data. Such a process can produce expressive 3D facial motion from audio in real time or near-real time (e.g., without significant delay) and with low latency. To retain independence from the details of the downstream animation system, such a system can output the per-frame positions of the control vertices of a fixed-topology facial mesh. Alternative encodings such as blend shapes or non-linear rigs can be introduced at later pipeline stages, if needed for compression, rendering, or editability. An example network can be trained using three to five minutes of high-quality footage obtained using traditional, vision-based performance capture methods. Such a process has been observed to successfully model the speaking style of not only a single actor, but also from other speakers with different gender, accent, or language. This flexibility can be useful for various applications or operations, as may relate to in-game dialogue, low-cost localization, virtual reality, augmented reality, mixed reality, enhanced reality, and telepresence, among other such options. Such an approach may also prove useful in accommodating small script changes even in cinematics.

An example and non-limiting deep neural network, including at least a CNN, consists of one special-purpose layer, ten convolutional layers, two fully-connected layers, and at least a transformer model with approximately six layers, which may be divided into three conceptual parts as illustrated in FIGS. 2 and 3. In at least one embodiment, systems and methods include a pipeline that receives input audio, processes the input audio through one or more CNN layers, processes an output of the CNN layers through one or more transformer layers, processes an output of the transformer layers through a linear combination layer, and then provides an output to an articulation layer. Various outputs from different layers may be routed to various other layers, as noted herein, such as providing each output from each transformer layer to the combination layer, and as a result, various embodiments may have a variety of different output vectors from various different layers that are processes, combined, modified, and/or the like. Data for an input audio window can be fed to a formant analysis network to produce a time-varying sequence of speech features that will subsequently drive articulation. Through training, the convolutional layers learn to extract short-term features that are relevant for facial animation, such as intonation, emphasis, and specific phonemes. Their abstract, time-varying representation can be the output of the final convolutional layer.

The result can be fed to a transformer that includes an encoder. The encoder may be a pre-trained audio encoder that is trained on a variety of different audio data, such as multiple languages, mixed languages, and the like. Parameters of the audio encoder may be frozen while other parameters of the system are changed during training. In this example, an articulation network may also form part of the deep neural network that consists of five further convolutional layers that analyze the temporal evolution of the features and eventually decide on a single abstract feature vector that describes the facial pose at the center of the audio window. As a secondary input, the articulation network accepts a (learned) description of emotional state and/or style (which may be referred to as a component vector) to disambiguate between different facial expressions and speaking styles. The emotional state, alone or with style data, can be represented as an E-dimensional vector that is concatenated directly onto the output of each layer in the articulation network, enabling the subsequent layers to alter their behavior accordingly.

Network architecture in at least one embodiment may include the CNN of the analysis network 208 (e.g., CNN 302) that has seven 1D (along time axis) convolutions in total. The convolution kernel size of the seven layers may be 10, 3, 3, 3, 3, 2, 2, respectively. The stride of convolution for the seven layers may be 5,2, 2, 2, 2, 2, 0.2. The output of convolution may have a shape 25 (time dimension)×512 (feature dimension), which is passed to a feature projection layer to change its shape to 25×768. This 25×768 shaped output may be fed to the transformer layers (e.g., layers 308) (which may include, for example, six layers or twelve layers, or any other reasonable number of layers), which output a feature with a shape 25×768 from each layer as well. These outputs may then passed to a linear combination layer (e.g., layer 312).

An example articulation network can output a set of 256+E+S abstract features that together represent the desired facial pose—e.g., E for the dimension of the emotion vector and S for the dimension of the style vector. These features can be fed to an output network to produce the final 3D positions of a set of control vertices in a tracking mesh in at least one embodiment. Moreover, in various embodiments, the output network computes PCA coefficients for the facial mesh (e.g., 140 in total), tongue mesh (e.g., 10 in total), and rigid transform coefficients for the eyeballs (e.g., four in total) and/or jaw (e.g., 15 in total). The output network can be implemented as a pair of fully-connected layers that perform a simple linear transformation on the data. The first layer maps the set of input features to the weights of a linear basis, and the set of second layers calculate the final PCA coefficients for face and tongue, rotation values for eyeballs, and the translational displacements for jaw and head. If the output network is computing 3D positions of vertices as output, the second layer can be initialized to, for example, 150 precomputed PCA components that together explain approximately 99.9% of the variance seen in the training data. In one or more embodiments, the two linear transformation layers of the output network may have an architecture such that the first transformation layer transform features a size 256+E+S to a feature of shape 169. Then the second transformation layer takes an input of shape 169 and outputs coefficients of shape 169 (140+10+4+15). The transformation layers weights may be randomly initialized.

A primary input to such a network is a speech audio signal, which may be converted to a format such as 16 kHz mono audio before feeding the audio to the network. The volume of each vocal track can be normalized to use a full [−1,+1] dynamic range, but such a system may or may not employ other kinds of processing, such as dynamic range compression, noise reduction, or pre-emphasis filter.

In one example implementation, 520 ms worth of audio was used as input, e.g., as 260 ms of past and future samples with respect to the desired output pose. This value was chosen to capture relevant effects, such as phoneme coarticulation, without providing too much data that might lead to overfitting.

Inferring facial animation from speech can be an inherently ambiguous problem, because the same sound can be produced with very different facial expressions. This is especially true with the eyes and eyebrows, since they have no direct causal relationship with sound production. Such ambiguities are also problematic for deep neural networks, because the training data will inevitably contain cases where nearly identical audio inputs are expected to produce very different output poses. If a network has nothing else to work with besides the audio, it will learn to output the statistical mean of the conflicting outputs.

An example approach to resolve such ambiguities is to introduce at least a secondary input to the network. A small amount of additional, latent data can be associated with each training sample, so that the network has enough information to unambiguously infer the correct output pose. This additional data can encode all relevant aspects of the animation in the neighborhood of a given training sample that cannot be inferred from the audio itself, including different facial expressions and coarticulation patterns. This secondary input can include a predefined label, and may represent at least an emotional state of the actor. Besides resolving ambiguities in the training data, such secondary input can also be highly useful for inference, as it enables a system to mix and match different emotional states with a given vocal track to provide powerful control over the resulting animation.

In addition to or alternatively from relying on predefined labels, a system in accordance with at least one embodiment can adopt a data-driven approach where the network automatically learns a succinct representation of the style as a part of the training process. This allows the system to extract meaningful emotional states even from in-character footage, as long as a sufficient range of emotions is present. In at least one embodiment, a style state can be represented by an S-dimensional vector, where S is a tunable parameter that can be set to a value such as, without limitation, 16 or 24, and the components initialized to random values drawn from a Gaussian distribution. One such vector can be allocated for each training sample, with the matrix that stores these latent variables being referred to herein as a style database. The style data can be appended to the list of activations of all layers of the articulation network, which can make it a part of the computation graph of the loss function and, as a trainable parameter, it can be updated along with the network weights during backpropagation. The dimensionality of S is a tradeoff between two effects in this example. If S is too low, the styles fail to disambiguate variations in the training data, leading to weak audio response. If Sis too high, styles may become too specialized to be useful for general inference.

Information provided by the audio can be limited to short-term effects within the, e.g., 520 ms interval by design. Consequently, a natural way to prevent the styles from containing duplicate information is to forbid them from containing short-term variation. Having the styles focus on longer-term effects may also be desirable for inference, as it may be desirable for the network to produce reasonable animation even when the emotional state remains fixed. This requirement can be expressed by introducing a dedicated regularization term in the loss function to penalize quick variations in the style database, which can lead to incremental smoothing of the emotional states over the course of training. One potential limitation to such an approach is that aspects such as blinking and eye motion may not be able to be modeled correctly since they do not correlate with the audio and cannot be represented using the slowly varying emotional state.

In embodiments, the emotional and style state may be appended to all layers of the articulation network to help to improve the results significantly in practice, as the emotional and style state can control the animation on multiple abstraction levels, and the higher abstraction levels may be more difficult to learn. Connecting to the earlier layers provides nuanced control over subtle animation features such as coarticulation, whereas connecting to the later layers provides more direct control over the output poses. The early stages of training can concentrate on the latter, while the later stages can concentrate on the former once the individual poses are reasonably well represented.

In one approach to training a deep neural network, an unstructured mesh with texture and optical flow data can be reconstructed from the, e.g., nine images captured for each frame. A fixed-topology template mesh, created prior to the capture work using a separate photogrammetry pipeline, can be projected on to the unstructured mesh and associated with the optical flow. The template mesh can be tracked across the performance and any issues are fixed semi-automatically, such as in software by a tracking artist. The position and orientation of the head can be stabilized using a few key vertices of the tracking mesh. Finally, the vertex positions of the mesh can be exported for each frame in the shot. These positions—or more precisely the deltas from a neutral pose—can be target outputs of this network when given a window of audio during training.

For each actor, a training set can consist of at least two parts: pangrams and in-character material. In general, the inference quality may increase as the training set grows, but a small training set may be highly desirable due to the cost of capturing high-quality training data. In at least one embodiment, it was empirically determined that around three to five minutes per actor represents a practical sweet spot. A pangram set can attempt to cover the set of possible facial motions during normal speech for a given target language, such as English. The actor speaks one to three pangrams, e.g., sentences that are designed to contain as many different phonemes as possible, in several different emotional tones to provide a good coverage of the range of expression. An in-character material set can leverage the fact that an actor's performance of a character is often heavily biased in terms of emotional and expressive range for various dramatic and narrative reasons. In the case of a movie or a game production, this material can be composed of the preliminary version of the script. Only the shots that are deemed to support the different aspects of the character are selected so as to ensure that the trained network produces output that stays in character even if the inference is not perfect, or if completely novel or out of character voice acting is encountered.

Given the potentially ambiguous nature of the training data, effort can be made to define a meaningful loss function to be optimized. In at least one embodiment, a specialized loss function can be used that consists of three distinct terms: a position term to ensure that the overall location of each output vertex is roughly correct, a motion term to ensure that the vertices exhibit the right kind of movement under animation, and a regularization term to discourage the style database from containing short-term variation.

Simultaneous optimization of multiple loss terms may be difficult in practice, because the terms can have wildly different magnitudes and their balance may change in unpredictable ways during training. One solution is to associate a pre-defined weight with each term to ensure that none of them gets neglected by the optimization. However, choosing optimal values for the weights can be a tedious process of trial and error that may need to be repeated whenever the training set changes. To overcome these issues, a normalization scheme can be used that automatically balances the loss terms with respect to their relative importance. As a result, an equal amount of effort can be devoted to optimizing each term, such that there is no need to specify any additional weights.

One error metric that can be used is the mean of squared differences between the desired output y and the output produced by the network 9. For a given training sample x, this can be expressed using position term P(x):

$$P ( x ) = \frac{1}{N} {\sum }_{i = 1}^{N} {( {y}^{( i )} ( x ) \to {\hat{y}}^{( i )} ( x ) )}^{2} \qquad ( 1 )$$

Here, N represents the total number of output features including 3D position of skin/tongue mesh vertices, rotation values of eyeballs, and translation displacement for jaw/head, and y⁽ⁱ⁾ denotes the ith scalar component of y=(y⁽¹⁾, y⁽²⁾, . . . , y^{(N)}). By way of example, N would be 61019 (e.g., 60000 for face mesh, 1000 for tongue mesh, 4 for rotation of eyes and 15 for translation of jaw).

Even though the position term ensures that the output of the network is roughly correct at any given instant in time, it may not be sufficient to produce high-quality animation in all instances. It was observed that training the network with the position term alone may lead to a considerable amount of temporal instability, and the response to individual phonemes is generally weak. Accordingly, a network can be optimized in terms of vertex motion as well: a given output vertex should only move if it also moves in the training data, and it should only move at the right time. A system can thus address vertex motion as a part of the loss function.

One approach for training neural networks is to iterate over the training data in minibatches, where each minibatch consists of B randomly selected training samples x₁, x₂, . . . , x_{B}. To account for vertex motion, we draw the samples as B/2 temporal pairs, each consisting of two adjacent frames. Operator m[⋅] can be defined as the finite difference between the paired frames, which allows defining motion term M(x) as:

$$M ( x ) = \frac{2}{N} {\sum }_{i = 1}^{N} {( m [ {y}^{i} ( x ) ] - m [ {\hat{γ}}^{( i )} ( x ) ] )}^{2} \qquad ( 2 )$$

In this equation, the factor 2 appears because M is evaluated once per temporal pair.

In addition, it can be beneficial to ensure that the network correctly attributes short-term effects to the audio signal and long-term effects to the emotional state. One approach can define a regularization term for the emotion/style database using the same finite differencing operator as above:

$${R}^{′} ( x ) = \frac{2}{E} {\sum }_{i = 1}^{E} {m [ {e}^{( i )} ( x ) ]}^{2} \qquad ( 3 )$$

Here, e⁽ⁱ⁾(x) denotes the ith component stored by the emotion database for training sample x. It can be noted that this definition does not explicitly forbid the emotion/style database from containing short-term variation—it instead discourages excess variation on average. This may be significant in at least some instances, as the training data may contain legitimate short-term changes in the emotional state occasionally, and it may be undesirable for the network to incorrectly try to explain them based on the audio signal.

A caveat with Eq. 3 is that R′(x) can be brought arbitrarily close to zero by simply decreasing the magnitude of e(x) while increasing the corresponding weights in the network. Drawing on the idea of batch normalization, this trivial solution can be removed by normalizing R^{t}(x) with respect to the observed magnitude of e(x):

$$R ( x ) = \frac{{R}^{′} ( x )}{( \frac{1}{EB} {\sum }_{i = 1}^{E} {\sum }_{j = 1}^{B} {{e}^{i} ( {x}_{j} )}^{2} )} \qquad ( 4 )$$

In order to balance these three loss terms, one approach is to leverage the properties of an Adam (or other) optimization method used for training the network. In effect, Adam updates the weights of the network according to the gradient of the loss function, normalized in a component-wise fashion according to a long-term estimate of its second raw moment. The normalization makes the training resistant to differences in the magnitude of the loss function, but this is only true for the loss function as a whole not for the individual terms. One approach is to perform similar normalization for each loss term individually. Using the position term as an example, the second raw moment of P(x) can be estimated for each minibatch and a moving average v^{P}ₜ maintained across consecutive minibatches, as may be given by:

$${v}_{t}^{p} = β \cdot {ν}_{t - 1}^{p} + ( 1 - β ) \cdot \frac{1}{B} {\sum }_{j = 1}^{B} P {( {x}_{j} )}^{2} \qquad ( 5 )$$

Here, t denotes the minibatch index and β is a decay parameter for the moving average that may be set to a value such as, without limitation, 0.99. The system can initialize vₜ^{p}=0 and correct the estimate to account for startup bias to get vₚ^{p}=vₜ^{p}/(1−β^{t}). The average P(x) can then be calculated over the current minibatch and the value normalized according to vₜ^{p}:

$${ℓ}^{P} = \frac{( \frac{1}{B} {\sum }_{f = 1}^{B} P ( {x}_{j} ) )}{( \sqrt{{\hat{v}}_{t}^{p} + ∈} )} \qquad ( 6 )$$

In Equation 6, ϵ is a small constant that can be set to a value such as 10⁻⁸ to avoid division by zero. Repeating Equations 7 and 8 for M(⋅) and R(⋅), a final loss function can be expressed as a sum over the individual terms l=l^{P}+l^{M}+l^{R}. In some embodiments, there may be further fine-tuning of the importance of the loss terms through additional weights.

Similarly, losses during training may also be associated with lip distance regularization and volume-based stability regularization, as described herein. For example, key points may be selected on lips (e.g., an upper lip and a lower lip) and then a minimum difference between predicted and ground truth distance between the key points. The loss may have higher weights when the ground truth lip distance is small (e.g., when the mouth closed). Moreover, loss may be added to penalize large motion between neighboring animation frames if the sound volume is low. Accordingly, the final loss can be further fine-tuned to include losses for one or both of lip distance or volume-based stability.

In at least one embodiment, random time-shifting can be employed for training samples to improve temporal stability and reduce overfitting. Whenever a minibatch is presented to the network, the input audio window can be randomly shifted by up to 16.6 ms in either direction (±0.5 frames at 30 FPS). To compensate, the same shift can be applied for the desired output pose through linear interpolation. Both training samples in a temporal pair can be shifted by the same amount, with different random shift amounts being used for different pairs. In some embodiments, cubic interpolation of outputs instead of or in addition to linear interpolation may be used.

In order to improve generalization and avoid overfitting, multiplicative noise can be applied to the input of individual convolutional layers. The noise can have the same magnitude for every layer, and can be applied on a per-feature map basis so that all activations of a given feature map are multiplied by the same factor. Identical noise can be applied to paired training samples to get a meaningful motion term. One formula for this noise is 1.4^{N(0, 1)}. There may be no other type of noise or augmentation applied to the training samples besides the time-shifting of input/outputs and multiplicative noise inside the network. Some approaches may, however, perform operations such as adjusting the volume, adding reverb (both long and short), performing time-stretching and pitch-shifting, applying non-linear distortion, random equalization, and scrambling the phase information, among other such options.

Once trained, a deep neural network can be evaluated at arbitrary points in time by selecting the appropriate audio window, leading to facial animation at the desired frame rate. The latency of such an approach may depend, at least in part, upon the audio window size, which may reach a period of time into the past and/or the future. Coarticulation can set a lower bound for the look-ahead; it has been observed that the look-ahead can be limited to a values such as 100 ms during training with little degradation in quality, even though some coarticulation effects may be longer. Shortening the look-ahead further than this may lead to a quick drop in perceived responsiveness in certain instances, so a realistic lower bound for the latency of one embodiment can be set to around 100 ms.

When inferring the facial pose for novel audio, the network can be supplied with an emotional state vector and/or a style vector as a secondary input, which may also be part of a single emotion vector. As part of training, the network can learn a vector (e.g., a latent E-dimensional vector) for each training sample, and this emotion database can be used to obtain robust emotion vectors that can be used during inference.

During training, the network can attempt to separate out the latent information—e.g., everything that is not inferable from the audio alone—into an emotion/style database. However, this decomposition may result in some amount of crosstalk between articulation and the overall expression. In practice, many of the learned emotion/style vectors may only be applicable in the neighborhood of their corresponding training frames and are not necessarily useful for general inference. In at least one embodiment, a process can mine for robust emotion/style vectors using a three-operation process. A problem experienced in many learned emotion vectors is that they deemphasize the motion of the mouth: when such a vector is used as a constant input when performing inference for novel audio, the apparent motion of the mouth may be subdued. One approach is to pick a few audio windows from a validation set that contain bilabials and a few that contain vowels, for which the mouth should be closed and open, respectively. The emotion/style database can then be scanned for vectors that exhibit the desired behavior for all chosen windows. Performing this preliminary culling for Character 1 resulted in 100 candidate emotion vectors for further consideration, and this response can vary with different emotion vectors.

A second operation in this example culling process is to play back the validation audio tracks and inspect the facial motion inferred with each of the candidate emotion/style vectors. At this stage, vectors can be discarded that result in subdued or spurious, unnatural motion, indicating that the vector may be tainted with short-term effects. This stage narrowed the set to 86 candidate emotion vectors for Character 1. As a third and final operation in this example, inference can be run on several seconds of audio from a different speaker and vectors with muted or unnatural response eliminated. With Character 1, this operation left 33 emotion vectors.

The output of the network can be examined for several novel audio clips with every remaining emotion/style vector, and a semantic meaning (e.g., “neutral”, “amused”, “surprised”, etc.) assigned to each of them, depending at least in part on factors such as the emotional state they convey. Which semantic emotions remain can depend on the training material, and it may not be possible to extract, e.g., a “happy” emotion if the training data does not contain enough such material to be generalizable to novel audio. Even after removing all but the best performing emotion vectors there can still be substantial variation to choose from. It was observed that emotion vectors mined in this way behave well under interpolation, e.g., sweeping from one emotion vector to another tends to produce natural-looking results. It therefore may be possible to vary the emotional state during inference based on high-level information from a game engine, or by manual keyframing.

The resulting facial animation can be highly stable. Primary sources of this temporal stability can include the motion term l^{M} and time-shift augmentation, but even with these techniques there may be still a small amount of jitter left, such as in the lip area at 4 ms timescale for some inputs. This may result from aliasing between neighboring audio frames around features such as stops and plosives. This can be mitigated, at least in part, using at least some amount of ensembling: the network is evaluated twice for a given animation frame, a time (e.g., 4 ms) apart, and the predictions are averaged.

As mentioned, such an approach can also support retargeting. When training the model, the output network may become specialized for a particular mesh. For many operations, it may be desirable to drive several different meshes using audio input. Approaches discussed herein can support retargeting of deformation, or transfer of deformation behavior between characters, or for the same character at different stages in life, among other such options.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

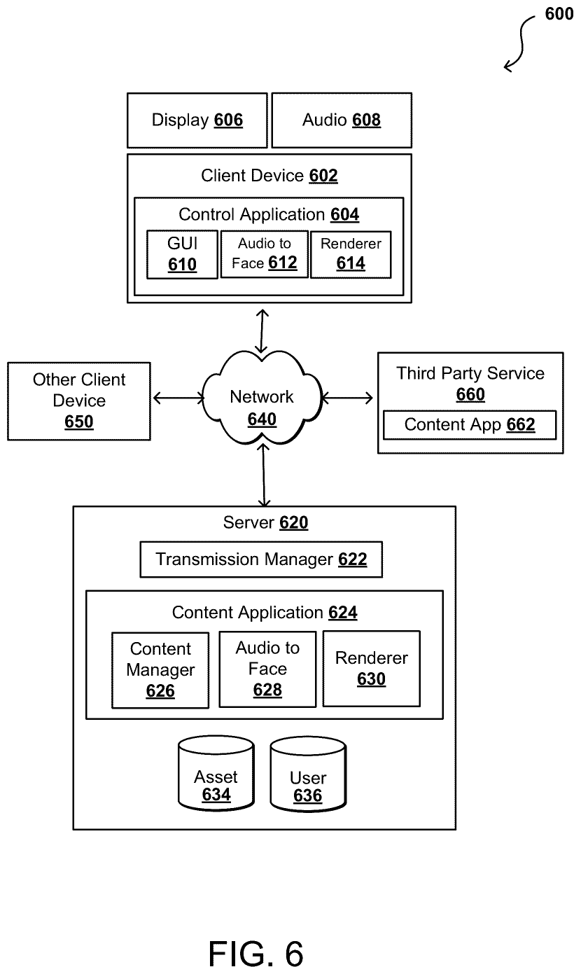

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an audio to face module 628 to generate or synthesize new objects, digital assets, or other such content to be provided for presentation via the client device 602. In at least one embodiment, this audio to face module 628 can use one or more neural networks, or machine learning models, which can be trained or updated using a training module 632 or system that is on, or in communication with, the server 620. This can include training and/or using a diffusion model 630 to generate content tiles that can be used by an audio to face module 628, for example, to apply a non-repeating texture to a region of an environment for which image or video data is to be presented via a client device 602, which may include using one or more renderers 630. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, an audio to face manager 612, and renderer 614 for use in providing, synthesizing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer. VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

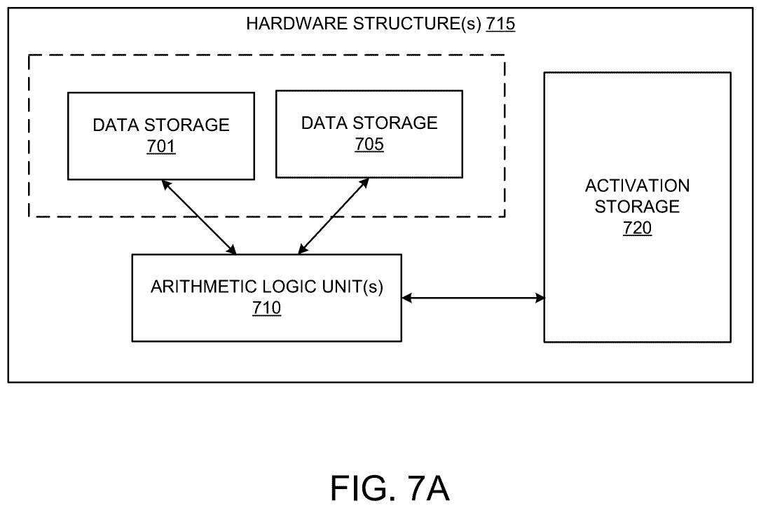

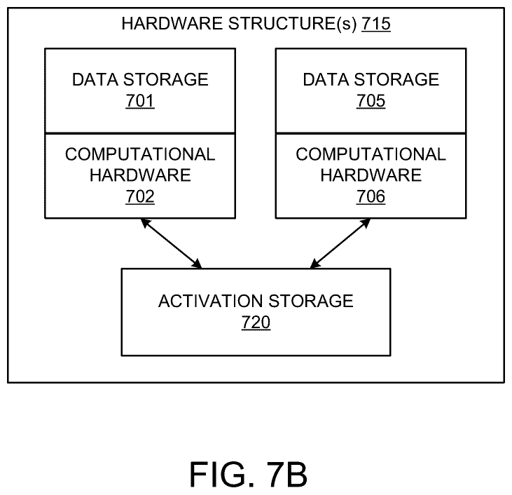

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g.. Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (JPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

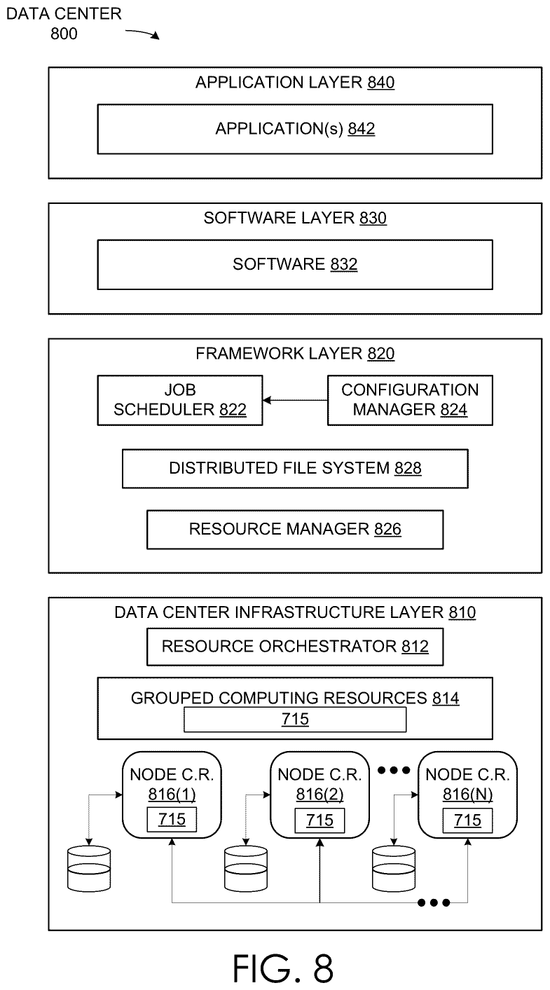

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(t)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services. Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(t)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for animation systems.

### Computer Systems

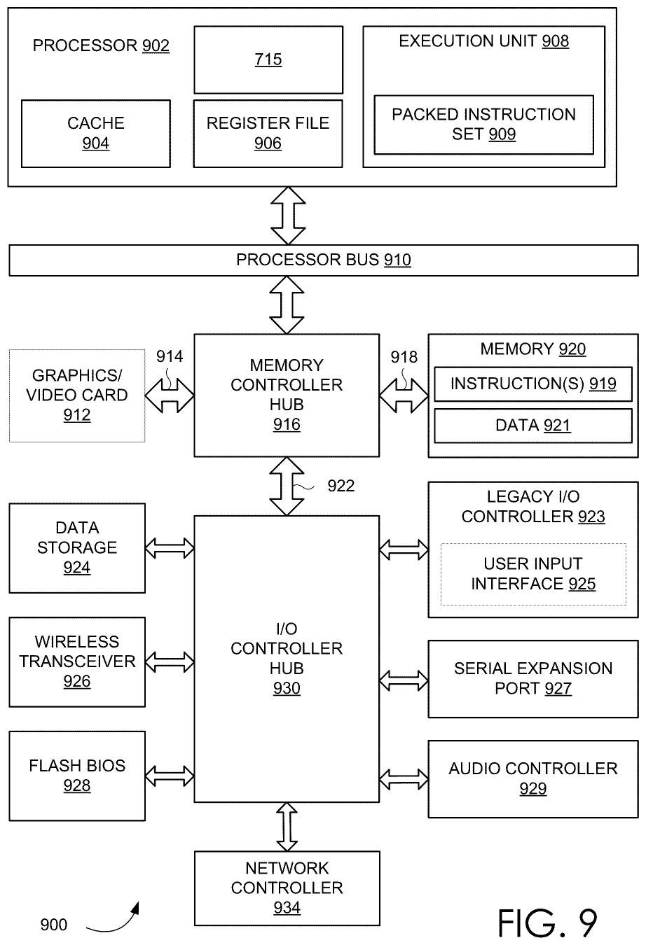

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902, In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system V/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCII 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for animation systems.

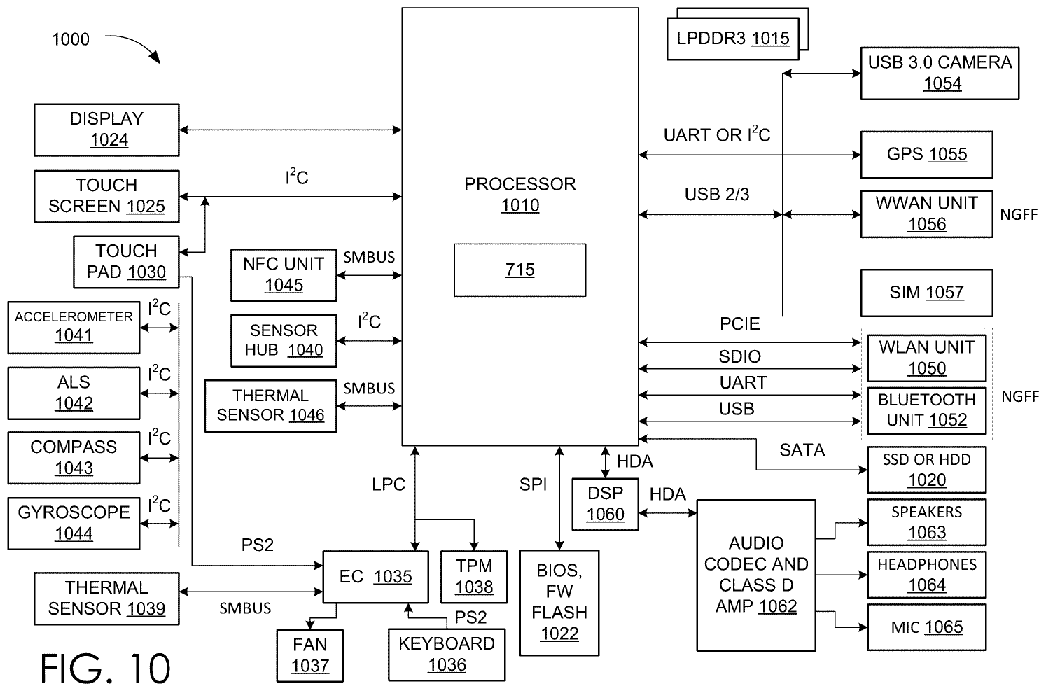

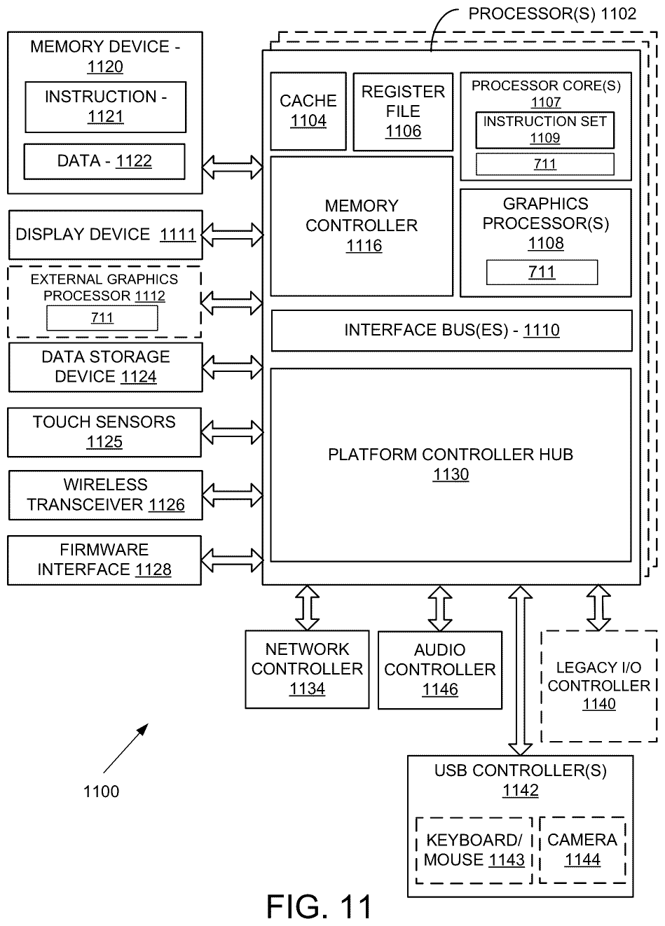

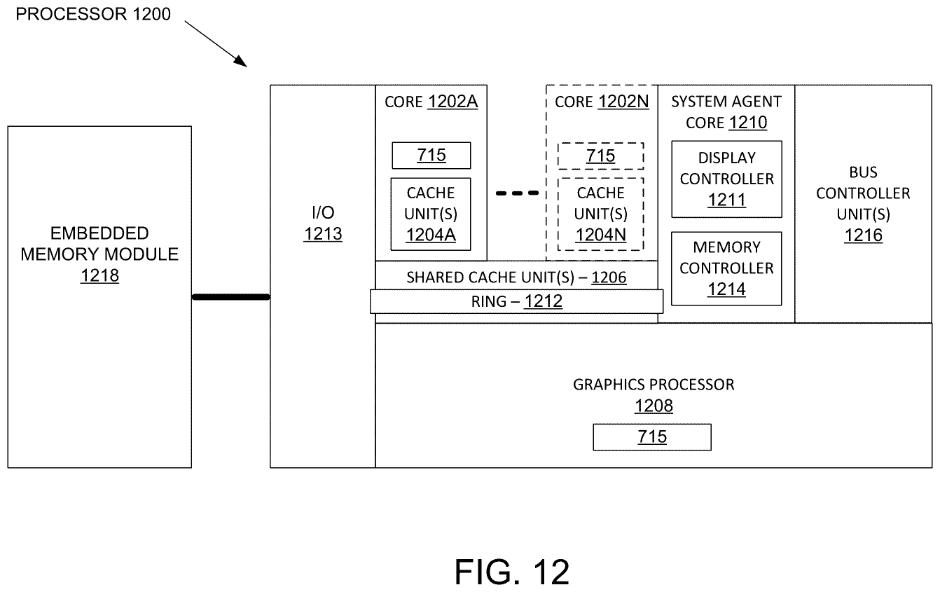

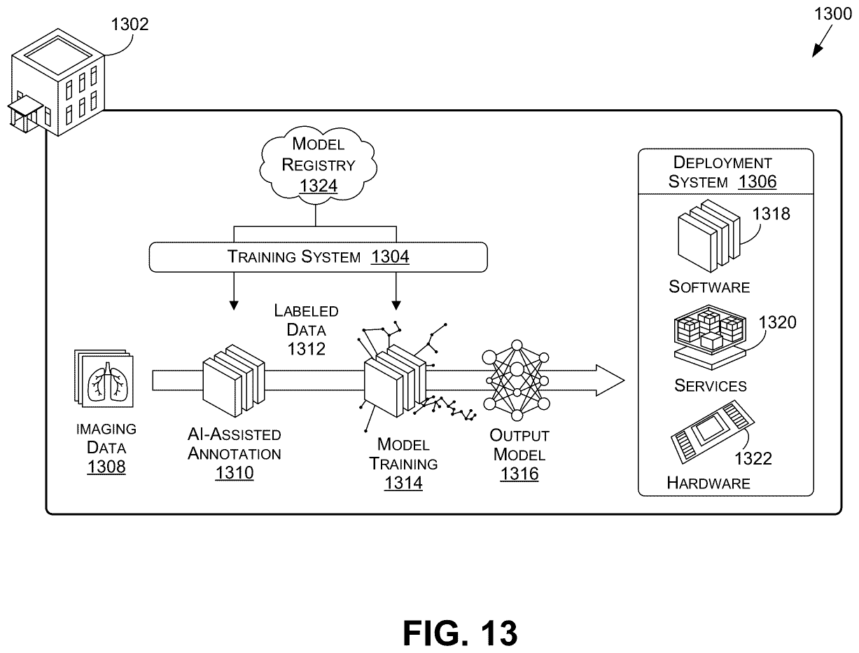

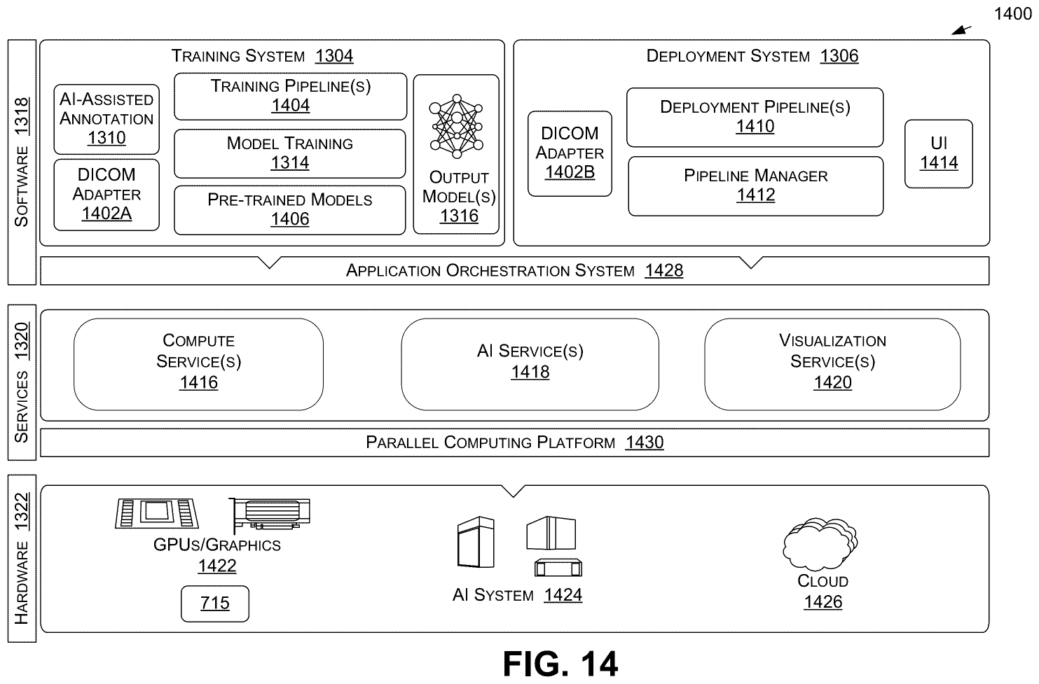

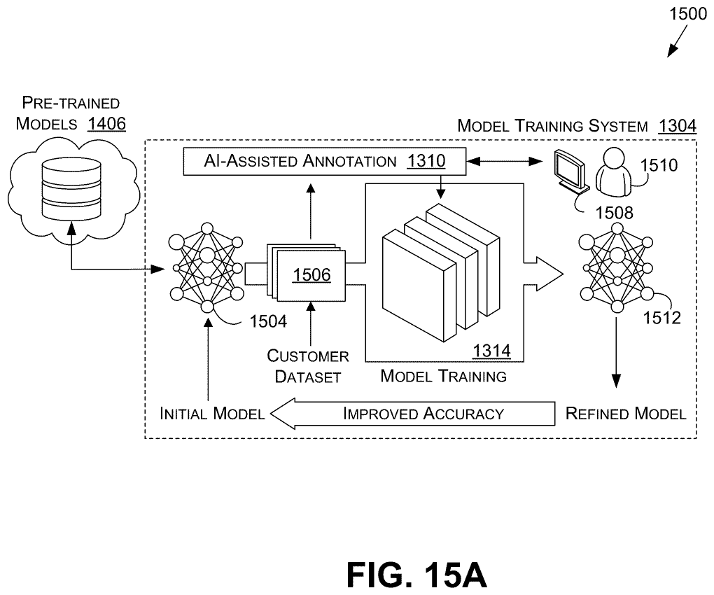

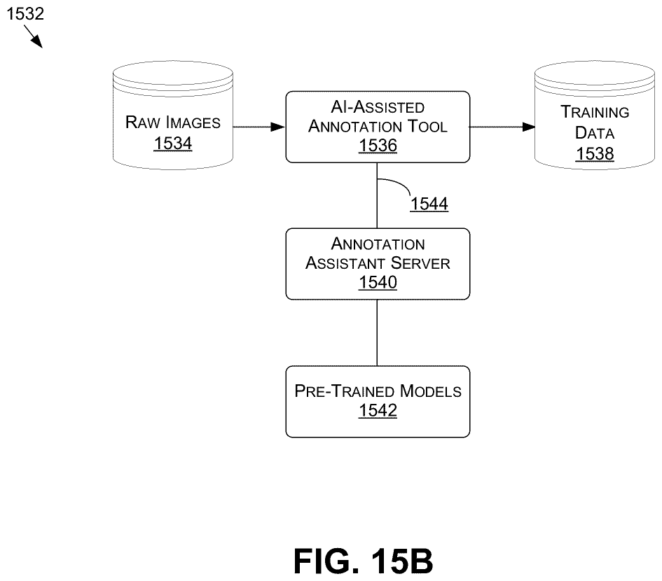

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used for animation systems.

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express), in at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for animation systems.

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used for animation systems.

### VIRTUALIZED COMPUTING PLATFORM

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine teaming models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine teaming models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine teaming model(s) associated with applications (e.g., tasked with performing one or more processing tasks of an application). In at least one embodiment, AI service(s) 1418 may leverage AI system 1424 to execute machine teaming model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1306 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK.) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine teaming models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:

1. A computer-implemented method, comprising:
receiving audio data corresponding to an utterance of speech;
computing, using a transformer-based audio encoder and a decoder, a weighted vector indicative of a plurality of features associated with the audio data;
computing, using the weighted vector and one or more component vectors, an animation vector corresponding to one or more positions for one or more feature points associated with a digital character representation; and
rendering the digital character representation based, at least, on the animation vector.

2. The computer-implemented method of clause 1, wherein the transformer-based audio encoder is a pre-trained audio encoder, further comprising:
training the decoder based, at least, on the transformer-based audio encoder, wherein parameters for the transformer-based audio encoder are locked while the decoder is trained.

3. The computer-implemented method of clause 1, wherein the plurality of features are selected during training.

4. The computer-implemented method of clause 1, further comprising:
receiving a respective layer vector associated with the plurality of features for layers of the transformer-based audio encoder;
determining, for individual layers, a layer weight;
applying the layer weight to the respective individual layer; and
determining the weighted vector.

5. The computer-implemented method of clause 1, wherein the audio data has a duration less than a threshold duration.

6. The computer-implemented method of clause 5, wherein the plurality of features are determined using transformer layers.

7. The computer-implemented method of clause 1, wherein the one or more feature points corresponds to at least one of facial features, a tongue position, an eye position, or an extremity position.

8. The computer-implemented method of clause 1, wherein the plurality of features are extracted from the audio data via processing using a convolutional neural network (CNN).

9. The computer-implemented method of clause 1, wherein the component vector includes at least one of an emotion vector or a style vector.

10. The computer-implemented method of clause 1, wherein the decoder disregards information from one or more previous frames.

11. The computer-implemented method of clause 10, further comprising:
penalizing motion between neighboring frames when a volume of the audio data is less than a volume threshold.

12. A processor comprising:
one or more processing units to:
   compute, using a transformer-based audio encoder and based, at least, on audio data corresponding to speech, a weighted feature vector associated with the audio data:
   compute, using the weighted feature vector and a component vector indicative of one or more properties associated with the speech, position data for one or more feature points of one or more deformable bodily components of a virtual character; and
   render, for one or more time points in a sequence of time points of the audio data, image data representative of the virtual character based, at least, on the position data to generate an animation of the character appearing to utter the speech.

13. The processor of clause 12, wherein the weighted feature vector is based, at least, on respective layer vectors for individual layers of the transformer-based audio encoder, wherein individual layer vectors are associated with a plurality of features extracted from the audio data.

14. The processor of clause 12, wherein parameters of the transformer-based audio encoder are locked during a training process for an associated decoder.

15. The processor of clause 12, wherein the component vector includes at least one of an emotion vector or a style vector.

16. The processor of clause 12, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or a system implemented at least partially using cloud computing resources.

17. A system, comprising:
one or more processing units to generate an animation of a character using position data representative of one or more positions of one or more feature points of the character, the position data computed based at least in part on a transformer-based audio encoder processing audio data representative of the speech and component data indicative of one or more values corresponding to at least one of a style parameter or an emotion parameter associated with the speech.

18. The system of clause 17, wherein the transformer-based audio encoder computes a weighted feature vector based, at least, on respective layer vectors for individual layers of the transformer-based audio encoder.

19. The system of clause 17, wherein parameters of the transformer-based audio encoder are locked during a training process for an associated decoder.

20. The system of clause 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: (A), {B}, {C), (A, B), (A, C}, {B, C), (A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating.” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
receiving audio data corresponding to an utterance of speech;
computing, using a transformer-based audio encoder and a decoder, a weighted vector indicative of a plurality of features associated with the audio data;
computing, using the weighted vector and one or more component vectors, an animation vector corresponding to one or more positions for one or more feature points associated with a digital character representation; and
rendering the digital character representation based, at least, on the animation vector.

2. The computer-implemented method of claim 1, wherein the transformer-based audio encoder is a pre-trained audio encoder, further comprising:
training the decoder based, at least, on the transformer-based audio encoder, wherein parameters for the transformer-based audio encoder are locked while the decoder is trained.

3. The computer-implemented method of claim 1, wherein the plurality of features are selected during training.

4. The computer-implemented method of claim 1, further comprising:
receiving a respective layer vector associated with the plurality of features for layers of the transformer-based audio encoder;
determining, for individual layers, a layer weight;
applying the layer weight to the respective individual layer; and
determining the weighted vector.

5. The computer-implemented method of claim 1, wherein the audio data has a duration less than a threshold duration.

6. The computer-implemented method of claim 5, wherein the plurality of features are determined using transformer layers.

7. The computer-implemented method of claim 1, wherein the one or more feature points corresponds to at least one of facial features, a tongue position, an eye position, or an extremity position.

8. The computer-implemented method of claim 1, wherein the plurality of features are extracted from the audio data via processing using a convolutional neural network (CNN).

9. The computer-implemented method of claim 1, wherein the component vector includes at least one of an emotion vector or a style vector.

10. The computer-implemented method of claim 1, wherein the decoder disregards information from one or more previous frames.

11. The computer-implemented method of claim 10, further comprising:
penalizing motion between neighboring frames when a volume of the audio data is less than a volume threshold.

12. A processor comprising:
one or more processing units to:
compute, using a transformer-based audio encoder and based, at least, on audio data corresponding to speech, a weighted feature vector associated with the audio data;
compute, using the weighted feature vector and a component vector indicative of one or more properties associated with the speech, position data for one or more feature points of one or more deformable bodily components of a virtual character; and
render, for one or more time points in a sequence of time points of the audio data, image data representative of the virtual character based, at least, on the position data to generate an animation of the character appearing to utter the speech.

13. The processor of claim 12, wherein the weighted feature vector is based, at least, on respective layer vectors for individual layers of the transformer-based audio encoder, wherein individual layer vectors are associated with a plurality of features extracted from the audio data.

14. The processor of claim 12, wherein parameters of the transformer-based audio encoder are locked during a training process for an associated decoder.

15. The processor of claim 12, wherein the component vector includes at least one of an emotion vector or a style vector.

16. The processor of claim 12, wherein the processor is comprised in at least one of:
a system for performing simulation operations;
a system for performing simulation operations to test or validate autonomous machine applications;
a system for performing digital twin operations;
a system for performing light transport simulation:
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application:
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.

17. A system, comprising:
one or more processing units to generate an animation of a character using position data representative of one or more positions of one or more feature points of the character, the position data computed based at least in part on a transformer-based audio encoder processing audio data representative of the speech and component data indicative of one or more values corresponding to at least one of a style parameter or an emotion parameter associated with the speech.

18. The system of claim 17, wherein the transformer-based audio encoder computes a weighted feature vector based, at least, on respective layer vectors for individual layers of the transformer-based audio encoder.

19. The system of claim 17, wherein parameters of the transformer-based audio encoder are locked during a training process for an associated decoder.

20. The system of claim 17, wherein the system comprises at least one of:
a system for performing simulation operations;
a system for performing simulation operations to test or validate autonomous machine applications:
a system for performing digital twin operations;
a system for performing light transport simulation:
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation:
a collaborative content creation platform for 3D assets; or
a system implemented at least partially using cloud computing resources.
